(19) United States
(12) Patent Application Publication
(10) Pub. No.: US 2015/0173042 A1
(43) Pub. Date: Jun. 18, 2015

(54) METHOD AND APPARATUS FOR INFORMING A RADIO OF A GROUP-CALL STARTED WHILE THE RADIO WAS AWAY FROM A CONTROL CHANNEL

(71) Applicant: MOTOROLA SOLUTIONS, INC, Schaumburg, IL (US)

(72) Inventors: YUEH CHING CHUNG, Georgetown (MY); THOMAS B. BOHN, Mc Henry, IL (US); DIPENDRA M. CHOWDHARY, Hoffman Estates, IL (US); HUN WENG KHOO, Gelugor (MY); SATYANARAYAN R. PANPALIYA, Palatine, IL (US); TEIK CHOON TEH, Jelutong (MY)

(73) Assignee: MOTOROLA SOLUTIONS, INC, Schaumburg, IL (US)

(21) Appl. No.: 14/106,622

(22) Filed: Dec. 13, 2013

(51) Int. Cl. H04W 72/00; H04W 72/04; H04W 64/00; H04W 4/08

(52) U.S. Cl. CPC H04W 72/005; H04W 4/08; H04W 72/0446; H04W 64/00

(57) ABSTRACT

A radio affiliates, via a first channel, with at least one talk group the radio is interested in receiving calls from, sends a request to transmit location information on a separate revert channel, and receives a first grant time period to transmit location information on a particular revert channel. The radio moves at substantially the first grant time period, away from the first channel to the revert channel to transmit location information or request a second grant time period on the revert channel, receives an announcement on the revert channel during the first grant time period that a call of interest associated with the at least one talk group started while the radio was on the revert channel, determines an assigned traffic channel for the call of interest, and switches from the revert channel to the assigned traffic channel in order to receive the call of interest.

### BACKGROUND OF THE INVENTION

In a trunked system, location information such as information received from a global positioning satellite (GPS) may be sent by a radio on a control channel or on a traffic channel. However, this may overload the control channel and may impact, for example, voice usage on the traffic channel. The location information (also referred to as GPS data or GPS information) may also be sent on a dedicated data channel (also referred to as a GPS revert channel or a revert channel). The GPS revert channel may be windowed or not windowed; wherein when the GPS revert channel is windowed each radio is assigned a specific time window to send the GPS data on the GPS revert channel. Subsequent to sending the GPS data in the specified window, the radio returns to the control channel. However, when the radio is on the GPS revert channel and away from the control channel, the radio is unaware of new calls that were started while the radio was away from the control channel. As the location information reporting increases, the time the radio spends away from the control channel also increases. When the radio returns to the control channel, the control channel sends reporting messages that lists all of the calls in progress. A radio may be affiliated with one or more talk groups such that the radio is interested in receiving calls associated with the affiliated talk groups. Using this approach, depending on the number of traffic channels supported by the control channel, a period of time, for example, a few seconds, may elapse before the radio becomes aware that a new call the radio is interested in receiving was started while the radio was away from the control channel. Therefore, the radio may miss the beginning of those calls started within the duration when the radio was away from control channel for GPS transmission.

Accordingly, there is a need for a method and apparatus for informing a radio about a group call that was stated while the radio was away from the control channel.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system used in accordance with some embodiments.

FIG. 2 is a block diagram of activity on a GPS revert channel in accordance with some embodiments.

FIG. 3 is a block diagram of a radio used in accordance with some embodiments.

FIG. 4 is a flow diagram of steps implemented in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Some embodiments are directed to apparatuses and methods for sending location information from a radio. The radio affiliates, via a first channel, with at least one talk group the radio is interested in receiving calls from, sends a request to transmit location information on a separate revert channel, and receives a first grant time period to transmit location information on a particular revert channel in response to the request. The radio moves at substantially the first grant time period, away from the first channel to the revert channel to transmit location information or request a second grant time period on the revert channel, receives an announcement on the revert channel after the first grant time period that a call of interest associated with the at least one talk group started while the radio was on the revert channel, determines an assigned traffic channel for the call of interest, and switches from the revert channel to the assigned traffic channel in order to receive the call of interest.

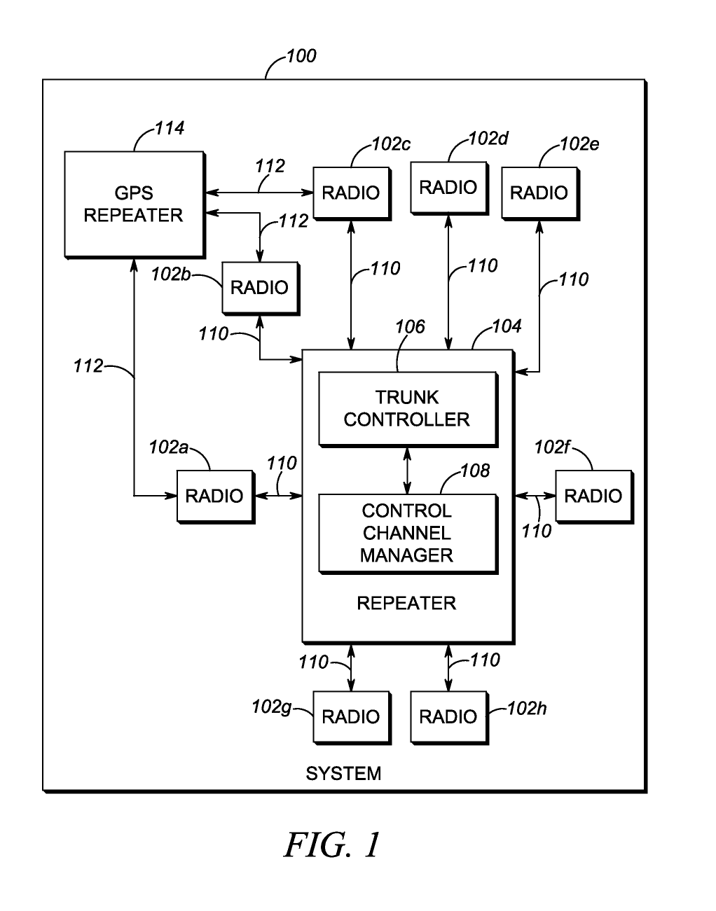

FIG. 1 is a block diagram of a system used in accordance with some embodiments. System 100 is a trunked system that includes one or more operating radios 102 (i.e., radios 102a-102h) configured to communicate with each other in a repeater mode via repeater 104. Radios 102 may be, for example, portable two-way radios or mobile radios and radios 102 that are configured to communicate via traffic channels 110 and receive control information from a control channel manager 108 via a control channel (not shown). One or more of radios 102, for example, radios 102a-102c, may need to provide location updates (referred to as GPS information or GPS data). Subsequent to entering system 100, radio 102a, for example, registers with GPS cadence information via the control channel and control channel manager 108. The GPS cadence information may include, for example, a GPS data update rate requested by radio 102a, wherein radio 102a periodically sends GPS data on a particular revert channel based on the update rate. The GPS cadence information may also include, for example, the radio identifier.

Control channel manager 108 requests at least one periodic window on a scheduled GPS revert channel 112 for radio 102a through a trunk controller 106. Trunk controller 106 keeps track of window assignments for radios 102 and GPS repeaters and uses the GPS cadence it received in the request from control channel manager 108 to determine a window number and a frame number that is granted to radio 102a. Trunk controller 106 sends the granted information to control channel manager 108. Control channel manager 108 then broadcasts the periodic window grant on GPS revert channel 112 and sends the current window number in a registration acknowledgment response to radio 102a on the control channel. In an embodiment, the registration response may include a number for the granted window/time period (the number for the granted window being referred to as a first grant window number), a frame number for the granted window, the current frame number and a window number for the current frame to help radio 102a in calculating when the radio is to switch over to GPS revert channel 112. The control channel manager 108 informs a GPS repeater 114 about the granted window number and frame number associated with the radio identifier for radio 102a.

Radio 102a is provisioned with a talk group list and performs talk group affiliation for all talk groups in the list (referred to herein as a receive talk group list), wherein the affiliation indicates that radio 102a is interested in receiving calls from the affiliated talk group(s). During the talk group affiliation, radio 102a may register one talk group or multiple talk groups with trunk controller 106 via the control channel and control channel manager 108. In an embodiment, radio 102a may register a talk group index that includes a number of talk groups the radio is interested in receiving calls from. The talk group index may also include priority information for the talk groups. In an embodiment, the talk group index may be programmed in trunk controller 106 in order to share the same talk group list of a particular index.

During registration, radio 102a can identify those talk groups in the talk group index the radio is interested in receiving calls from. Control channel manager 108 sends the radio IDs for the identified radios 102 with the receive talk group lists associated with indexes or talk groups (i.e., in one talk group registration case) to the trunk controller 106. Trunk controller 106 passes the receive talk group lists associated with the received indexes or talk groups associated with the identified radio IDs to control channel manager 108. Control channel manager 108 forwards this information to GPS repeater 114 so that GPS repeater 114 can maintain a list of radio identifiers and the associated received talk group list/talk group for each radio identifier. Accordingly, both radio 102a and GPS repeater 114 may be programmed with the same receive talk group list for radio 102a. Thereafter, when a group call starts or ends on traffic channel 110, trunk controller 106 passes the call status start information to control channel manager 108. Control channel manager 108 has knowledge of call status end information through the traffic channel repeater 104. Control channel manager 108 sends call status information (for example, start or end) to GPS repeater 114. GPS repeater 114, control channel manager 108 and trunk controller 106 may be connected by wireline in a local area network if they are at the same site. GPS repeater 114, control channel manager 108 and trunk controller 106 may be connected by wireline in a wide area network if they are at different sites. In an embodiment, control channel manager 108 and GPS repeater 104 may be connected by wireline in a local area network. For ease of illustrations, the connections between the components of repeater 104, GPS revert channel 112 and/or GPS repeater 114 are not shown in FIG. 1.

Based to the talk group affiliation request sent by radio 102a during registration, the system is aware of the talk groups radio 102a is interested in receiving calls from while radio 102a is away from the control channel. When it is time for radio 102a to transmit GPS information on GPS revert channel 112, radio 102a switches away from the control channel to GPS revert channel 112. After the GPS transmission on the GPS revert channel 112 uplink, radio 102a monitors the GPS revert channel 112 downlink for an upcoming announcement to determine if a call of interest started when radio 102a was transmitting the GPS information. If, using the information in the receive talk group list, the radio ID and the call status information from trunk controller 106 and control channel manager 108, GPS repeater 114 determines that a call of interest started while radio 102a was transmitting the GPS information, GPS repeater 114 adds the traffic channel ID for the call to an upcoming announcement on GPS revert channel 112. In the case where calls were started in two or more talk groups of interest to radio 102a, GPS repeater 114 may add the traffic channel ID of only the higher or highest priority talk group call to the upcoming announcement. Radio 102a can then switch directly to the traffic channel included in the announcement after decoding the announcement burst, and receive the call of interest. The system therefore sends the traffic channel information for new calls to radio 102a so that radio 102a can go directly to that traffic channel upon tuning away from GPS revert channel 112.

If no call of interest was started while radio 102a was transmitting the GPS information, radio 102a switches back to the control channel. To avoid missing any call grant on the control channel, radio 102a may store synchronization information of the control channel. Accordingly, when radio 102a returns to the control channel, it may use the stored timing and skip the slot structure process.

In some cases, radio 102a may request one time window or periodic windows on GPS revert channel 112, during run time. For example, if radio 102a fails to send GPS information because it was involved in a call on a traffic channel 110 during the assigned window on revert channel 112, radio 102a may go to GPS revert channel 112 to send a request for one or more other periodic windows or one-time window on GPS revert channel 112. While radio 102a is sending the request on GPS revert channel 112, radio 102a may similarly miss a call that started when the radio was on GPS revert channel 112 and away from the control channel. Therefore, while radio 102a is on GPS revert channel 112, either to send GPS information or request a time window on GPS revert channel 112, GPS repeater 114 announces any call of interest to radio 102a in a next announcement. The GPS repeater 114 may announce a one-time window grant or periodic window grant in the next announcement only if there is no call of interest for radio 102a.

Radio 102a may use a first period in the granted window on GPS revert channel 112 to send GPS data and radio 102b may use a second period in the same window on GPS revert channel 112 to send a request for another GPS window. The first and second periods in a window may be distinct sub-periods in the window. An announcement sent after the window used by radios 102a and 102b may include call information for one or both of radios 102a and 102b. In the case where both radios 102a and 102b receive calls of interest during the time those radios were on GPS revert channel 112, the GPS repeater 114 may broadcast the traffic channels for both calls in the next announcement. In the case where radio 102b receives a call of interest while on GPS revert channel 112 but radio 102a does not, the GPS repeater may broadcast the traffic channel for the call of interest to radio 102b. In this case, because voice has higher priority than data, the request from radio 102a will not be granted so radio 102a may return to the control channel and start a random hold-off to retry later. Hence, radio 102b may join the call of interest, but because radio 102a does not have a call of interest, radio 102a can retry later. If radio 102a received a call of interest while on GPS revert channel 112, but not radio 102b, the GPS repeater may broadcast the traffic channel for the call of interest to radio 102a. In this case, because voice has higher priority than data, the request from radio 102b will not be granted so radio 102b may return to the control channel and start a random hold-off to retry later. Hence, radio 102a may join the call of interest, but because radio 102b does not have a call of interest, radio 102b can retry later. If both radios have no on-going calls of interest, then the GPS repeater 114 may use a burst to announce the grant for radio 102b and radio 102a returns to control channel. In an embodiment, the GPS repeater 114 obtains the GPS window grant from the trunk controller 106.

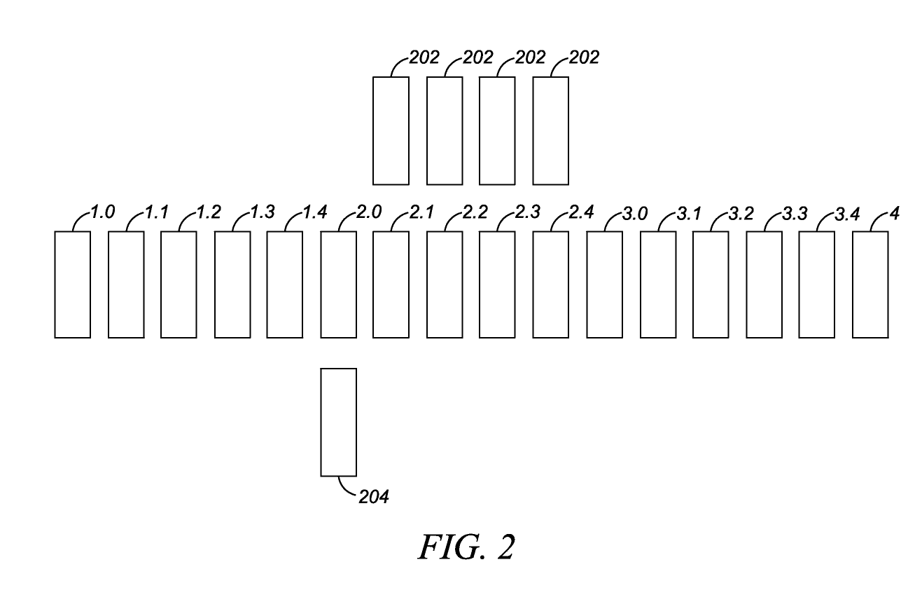

FIG. 2 is a block diagram of activity on a GPS revert channel in accordance with some embodiments. In timeslot 1.1, a first radio leaves the control channel. During timeslots 1.1-1.4, the first radio switches to the revert channel and performs slot locking. During timeslots 2.1-2.4, the first radio sends GPS data over the GPS revert channel, as shown by the blocks labeled 202. In an embodiment, if the first radio failed to send GPS information during an assigned window, at slot 2.0, for example, the first radio may request a one-time window or a periodic window on the GPS revert channel during run time. In addition, while the first radio is sending GPS data in timeslots 2.1-2.4, a second radio that failed to send GPS information during an assigned window, may request a one-time window or a periodic window on the GPS revert channel during run time in slot 2.0, as shown by block 204. During timeslots 3.1-3.4, the first radio and the second switch from the revert channel back to the control channel. Accordingly, from slot 1.0 to slot 4, the radios may be away from the control channel. In an embodiment, at slot 3.0, the GPS revert channel sends an announcement with the traffic channels being used for calls the first and second radios are interested in receiving. The diagram shown in FIG. 2 may be used in wireline data setup. The first and second radios may refer to the same announcement for call information.

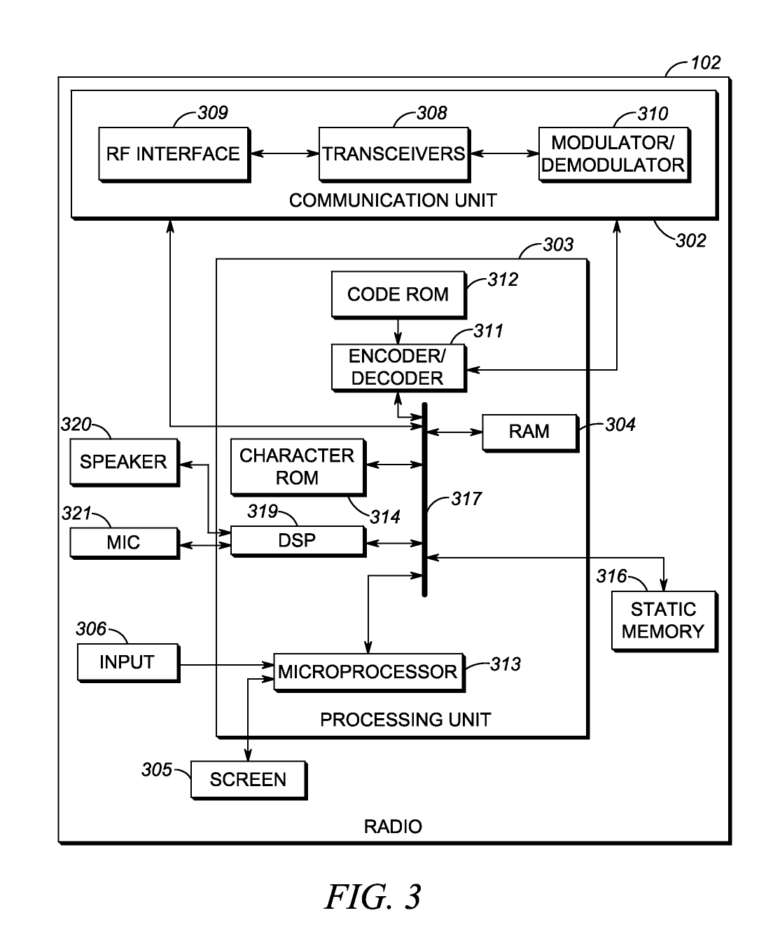

FIG. 3 is a block diagram of a radio used in accordance with some embodiments. Radio 102 includes a communications unit 302 coupled to a common data and address bus 317 of a processing unit 303. Radio 102 may also include an input unit (e.g., keypad, pointing device, etc.) 306, an output transducer unit (e.g., speaker) 320, an input transducer unit (e.g., a microphone) (MIC) 321, and a display screen 305, each coupled to be in communication with the processing unit 303. The speaker/microphone configuration may be configured with Push-To-Talk capability and/or Voice over IP (VoIP) capability.

Processing unit 303 may include an encoder/decoder 311 with an associated code ROM 312 for storing data for encoding and decoding voice, data, control, or other signals that may be transmitted or received by radio 102. Processing unit 303 may further include a microprocessor 313 coupled, by the common data and address bus 317, to the encoder/decoder 311, a character ROM 314, a RAM 304, and a static memory 316. The processing unit 303 may also include a digital signal processor (DSP) 319, coupled to the speaker 320, the microphone 321, and the common data and address bus 317, for operating on audio signals received from one or more of the communications unit 302, the static memory 316, and the microphone 321.

Communications unit 302 may include an RF interface 309 configurable to communicate with network components, and other user equipment within its communication range. Communications unit 302 may include one or more broadband and/or narrowband transceivers 308, such as an Long Term Evolution (LTE) transceiver, a Third Generation (3G) (3GGP or 3GGP2) transceiver, an Association of Public Safety Communication Officials (APCO) Project 25 (P25) transceiver, a Digital Mobile Radio (DMR) transceiver, a Terrestrial Trunked Radio (TETRA) transceiver, a WiMAX transceiver perhaps operating in accordance with an IEEE 802.16 standard, and/or other similar type of wireless transceiver configurable to communicate via a wireless network for infrastructure communications. Communications unit 302 may also include one or more local area network or personal area network transceivers such as Wi-Fi transceiver perhaps operating in accordance with an IEEE 802.11 standard (e.g., 802.11a, 802.11b, 802.11g), or a Bluetooth transceiver. The transceivers may be coupled to a combined modulator/demodulator 310 that is coupled to the encoder/decoder 311.

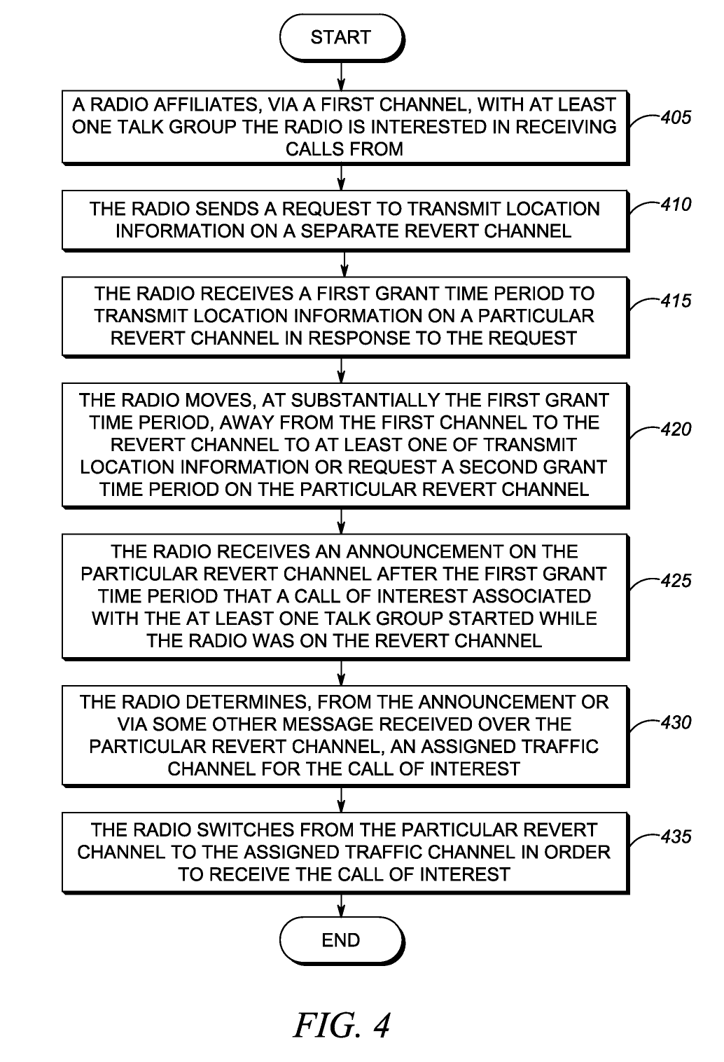

The character ROM 314 stores code for decoding or encoding data such as control, request, or instruction messages, channel change messages, and/or data or voice messages that may be transmitted or received by radio 102. Static memory 316 may store operating code for performing one or more of the steps set forth in FIG. 4.

FIG. 4 is a flow diagram of steps implemented in accordance with some embodiments. At 405, a radio affiliates, via a first channel, with at least one talk group the radio is interested in receiving calls from. At 410, the radio sends a request to transmit location information on a separate revert channel. At 415, the radio receives a first grant time period to transmit location information on a particular revert channel in response to the request. At 420 the radio moves, at substantially the first grant time period, away from the first channel to the revert channel to at least one of transmit location information or request a second grant time period on the particular revert channel. At 425, the radio receives an announcement on the particular revert channel after the first grant time period that a call of interest associated with the at least one talk group started while the radio was on the revert channel. At 430, the radio determines, from the announcement or via some other message received over the particular revert channel, an assigned traffic channel for the call of interest. At 435, the radio switches from the particular revert channel to the assigned traffic channel in order to receive the call of interest. More specifically, the radio is able to switch directly to the assigned traffic channel from the particular revert channel without tuning to the control channel in between.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
affiliating, by a radio via a first channel, with at least one talk group the radio is interested in receiving calls from;
sending, by the radio, a request to transmit location information on a separate revert channel;
receiving, by the radio, a first grant time period to transmit location information on a particular revert channel in response to the request;
moving, by the radio at substantially the first grant time period, away from the first channel to the particular revert channel to at least one of transmit location information and transmit a request for a second grant time period on the particular revert channel;
receiving, by the radio, an announcement on the particular revert channel after the first grant time period that a call of interest associated with the at least one talk group started while the radio was on the particular revert channel;
determining, by the radio, an assigned traffic channel for the call of interest; and
switching, by the radio, from the particular revert channel to the assigned traffic channel in order to receive the call of interest.

2. The method of claim 1, wherein the receiving the first grant time period comprises receiving at least one of a first grant window number, a frame number for the first grant time period, a current frame number, and a current window number in a registration acknowledgment broadcast from a control channel manager.

3. The method of claim 1, wherein the affiliating comprises registering a plurality of talk groups and including priority information for the priority of talk groups.

4. The method of claim 3, wherein the determining the assigned traffic channel for the call of interest includes determining the assigned traffic channel for the call of interest associated with a talk group with a highest priority.

5. The method of claim 1, further comprising sending, by a controller, a radio identifier identifying the radio and an identity of the at least one talk group to a location repeater associated with the particular revert channel.

6. The method of claim 1, further comprising:
moving, by the radio at substantially the second grant time period, away from the first channel to the particular revert channel to transmit location information;
receiving, by the radio, an announcement on the particular revert channel during the second grant time period indicating whether a call of interest associated with the at least one talk group started while the radio was on the particular revert channel;
determining, by the radio, that the call of interest was not started; and
switching to a current control channel.

7. The method of claim 6, further comprising storing synchronization information for the current control channel and using stored timing information in switching to the current control channel subsequent to determining that the call of interest was not started.

8. The method of claim 1, further comprising obtaining the second grant time period.

9. The method of claim 1, wherein the moving to the particular revert channel comprises sending, by the radio, the location information on the particular revert channel during a first period in the first grant time period, and
sending, by another radio, the request for the second grant time period during a second period in the first grant time period.

10. The method of claim 9, further comprising one of:
determining, by each of the radios, based on the receiving the announcement that calls of interest were started for each of the radios and obtaining, by each of the radios, the traffic channel for the associated call of interest; and
determining, by each of the radios, based on the receiving the announcement that a call of interest was started for one of the radios and obtaining, by the radio determined to have a call of interest, the traffic channel for the call and returning, by the radio determined not to have a call of interest, to a current control channel.

11. A radio comprising;
a memory configured to store a list of talk groups the radio is interested in receiving calls from;
a transceiver; and
a processor configured to:
affiliate, via the transceiver and a first channel, with at least one talk group the radio is interested in receiving calls from;
send, via the transceiver, a request to transmit location information on a separate revert channel;
receive, via the transceiver, a first grant time period to transmit location information on a particular revert channel in response to the request;
tune, via the transceiver, at substantially the first grant time period, away from the first channel to the particular revert channel to at least one of transmit location information and transmit a request for a second grant time period on the particular revert channel;
receive, via the transceiver, an announcement on the particular revert channel after the first grant time period that a call of interest associated with the at least one talk group started while the radio was on the particular revert channel;
determine an assigned traffic channel for the call of interest; and
switch from the particular revert channel to the assigned traffic channel in order to receive the call of interest.

12. The radio of claim 11, wherein the processor is configured to receive, via the transceiver, at least one of the first grant window number, a frame number for first grant time period, a current frame number, and a current window number in a registration acknowledgment broadcast from a control channel manager.

13. The radio of claim 11, wherein the processor is configured to register a plurality of talk groups and include priority information for the priority of talk groups.

14. The radio of claim 13, wherein the processor is configured to determine the assigned traffic channel for the call of interest associated with a talk group with a highest priority.

15. The radio of claim 11, wherein the processor is configured to:
move at substantially the second grant time period away from the first channel to the particular revert channel to transmit location information;
receive an announcement on the particular revert channel during the second grant time period indicating whether a call of interest associated with the at least one talk group started while the radio was on the particular revert channel;
determine that the call of interest was not started; and
switch to a current control channel.

16. The radio of claim 15, wherein the processor is configured to store, in the memory, synchronization information for the current control channel and use stored timing information in switching to the current control channel subsequent to determining that the call of interest was not started.

17. The radio of claim 11, wherein the processor is configured to obtain the second grant time period.

18. The radio of claim 11, wherein the processor is configured to send the location information on the particular revert channel during a first period in the first grant time period, and
wherein the processor of another radio is configured to send the request for the second grant time period during a second period in the first grant time period.

19. The radio of claim 18, wherein the processors of each of the radios are configured to:
determine, based on the receiving the announcement, that calls of interest were started for each of the radios and obtain the traffic channel for the associated call of interest; and
determine, based on the receiving the announcement that a call of interest was started for one of the radios and obtain, by the processor of the radio determined to have a call of interest, the traffic channel for the call and return, by the processor of the radio determined not to have a call of interest, to a current control channel.
